(19) United States
(12) Patent Application Publication
(10) Pub. No.: US 2005/0113952 A1
(43) Pub. Date: May 26, 2005

(54) Design method for antenna and antenna using the same

(75) Inventors: Hidehito Shimizu, Neyagawa-shi (JP); Yukinori Sasaki, Nishinomiya-shi (JP); Yuki Satoh, Osaka-shi (JP)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 10/975,586

(22) Filed: Oct. 28, 2004

(30) Foreign Application Priority Data
Oct. 30, 2003 (JP) 2003-370388
Apr. 15, 2004 (JP) 2004-120146

(51) Int. Cl. G06F 9/45

(52) U.S. Cl. 700/97; 716/5

(57) ABSTRACT

A design method for an antenna which shortens the time for antenna design and greatly contributes to reduction in costs of antenna development, and an antenna using the same are provided. This design method for the antenna can design an optimum antenna matching with the configuration of a cellular telephone for a short time. This design method for the antenna uses a database prepared beforehand and a relational expression obtained from design parameters and characteristic parameters, and can obtain desired antenna characteristics for a short time.

### FIELD OF THE INVENTION

The present invention relates to a design method for an antenna used for cellular telephones and the like, and an antenna designed by using this design method.

### BACKGROUND OF THE INVENTION

Recent devices relating to information have the trend to be reduced in size. As associated with this, the wave of reduction in size and profile is coming to various electronic components. Antennas mounted on cellular telephones and the like are not exception of this trend as well, which are demanded for reduction in size. However, generally, when antennas are reduced in size, the radiation efficiency of electromagnetic waves is decreased as well as increased sensitivity with respect to peripheral components. Therefore, the design for antennas is required in consideration of influence of cases for cellular telephones and peripheral components of the antennas. In the traditional antenna design, a case for a cellular telephone and peripheral components of an antenna are used to repeatedly form prototypes, and then the antenna characteristics are optimized. Generally, there is a wide variety of the shapes of cases for cellular telephones and circuit boards on which antennas are mounted and the shapes and arrangements of peripheral components of antennas (varied according to customers and types). Thus, since design guidelines in the past cannot be applied, it is necessary to repeatedly form prototypes with cases for cellular telephones and peripheral components of antennas. The design period of time is prolonged, further causing a problem of increased costs. As disclosed in JP-A-11-161690, electromagnetic field simulations are utilized as an antenna design method.

### SUMMARY OF THE INVENTION

A design method for an antenna includes the steps of:
determining a material and dimensions of individual parts forming an antenna as design parameters;
then comparing values of the design parameters with a database;
acquiring characteristics of a database when there is the database with which the design parameters are matched in the comparison step; and
acquiring characteristics predicted from a relational expression obtained by interpolating or extrapolating data in the database when there is no database with which the design parameters are matched in the comparison step.

An antenna is designed by using this design method for an antenna.

### BRIEF DESCRIPTION OF THE DRAWINGS

FIG. 1 is a flow chart illustrating the characteristic analysis of an antenna for a cellular telephone according to the invention;

FIG. 2 is a front view illustrating a monopole antenna mounted on a circuit board having a shielding case;

FIG. 3 is a side view illustrating the monopole antenna mounted on the circuit board having the shielding case;

FIG. 4 is a diagram illustrating the frequency response of VSWR with one resonance in the range of evaluating the impedance characteristics;

FIG. 5 is a diagram illustrating the frequency response of VSWR with two resonances in the range of evaluating the impedance characteristics;

FIG. 6 is a diagram illustrating the frequency response of the radiation efficiency in the range of evaluating the impedance characteristics;

FIG. 7 is a diagram illustrating a database when the design parameters have three variables, and the characteristic parameters have three variables; and

FIG. 8 is a conceptual diagram illustrating a neural network.

### DETAILED DESCRIPTION OF THE EXEMPLARY EMBODIMENTS

However, in the traditional electromagnetic field simulations described above, a simulation model becomes complicated and great in scale, when a case, a circuit board, and peripheral components of an antenna are considered accurately. On this account, simulation requires several days.

In order to solve this problem, the invention utilizes the database of characteristic parameters, or a relational expression between the antenna design parameters and the characteristic parameters, and thus it can obtain the result of desired characteristic parameters without performing electromagnetic field simulations. Accordingly, the invention has an advantage to shorten the time to a few seconds to obtain the characteristic parameters of an antenna after a material and dimensions of the individual parts forming an antenna are determined.

### Embodiment 1

Hereinafter, Embodiment 1 according to the invention will be described with reference to the drawings.

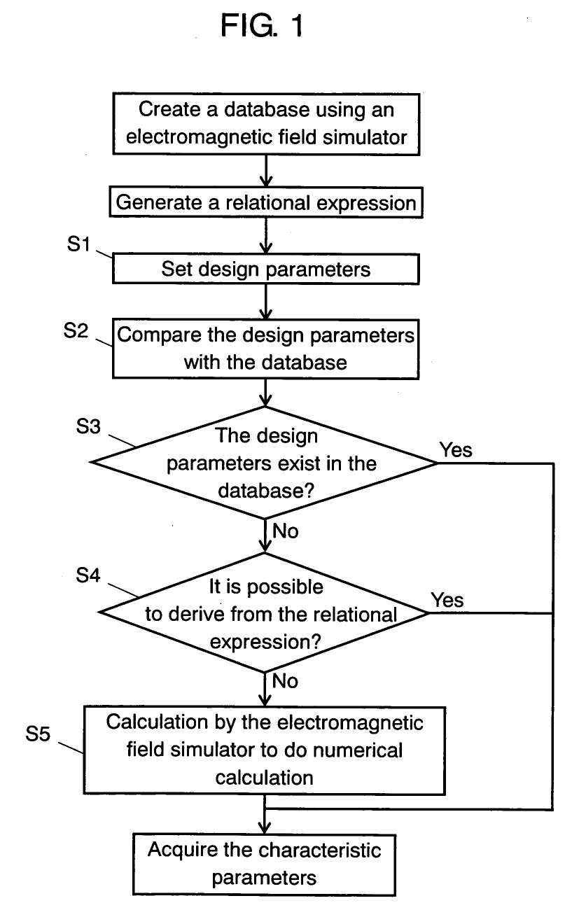

First, in designing an antenna according to the invention, two process steps are required: the process step of creating a database, and the process step of generating a relational expression. FIG. 1 shows a flow chart illustrating the characteristic analysis of an antenna for a cellular telephone of the embodiment according to the invention including the two process steps.

In implementing the invention, a material and dimensions of individual parts are set, which are design parameters of forming an antenna (Step S1). The values of the inputted design parameters are compared with a database (Step S2). Here, in this comparison process step, when there is data matching with the design parameters, the characteristics of the database are acquired (Step S3). When there are no data parameters matching with the design parameters in the comparison process step at Step 2, the characteristics are acquired that are predicted from a relational expression obtained by interpolating or extrapolating the data in the database (Step S4). Here, when input is done beyond the range expressed by the relational expression, an electromagnetic field simulator is used to perform numerical calculation (Step S5), and the characteristics are acquired. The calculation result obtained at this time is newly added to the database.

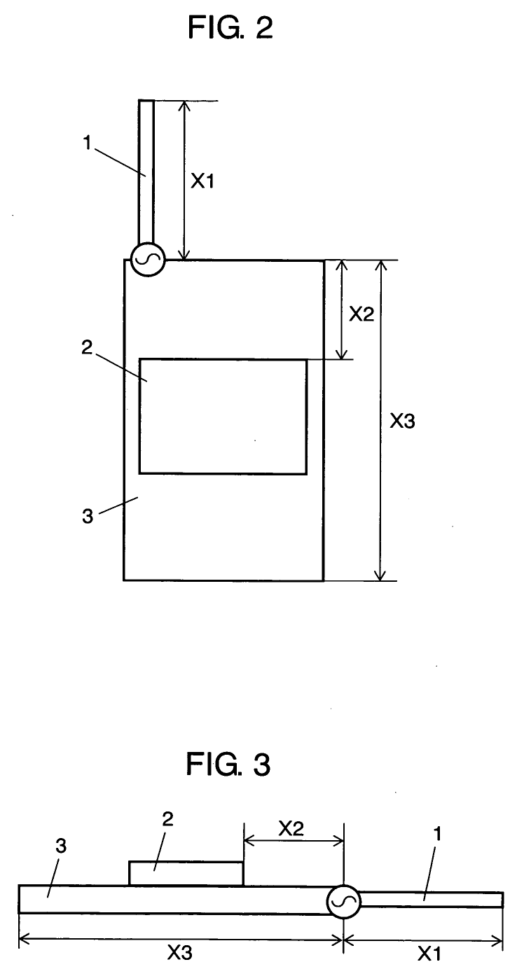

The exemplary system construction will be described prior to implementing the invention. FIG. 2 is a front view illustrating a monopole antenna when it is mounted on a circuit board, and FIG. 3 is a side view illustrating the monopole antenna when it is mounted on the circuit board. Here, in FIG. 2, the length of antenna element 1 made of pure copper in the longitudinal direction is set to X1, the distance from the end part of the antenna to the end of shielding case 2 mounted on circuit board 3 is set to X2, and the length of circuit board 3 in the longitudinal direction is set to X3.

Subsequently, in order to create a database, an electromagnetic field simulator is used to perform numerical calculation for 27 types of data in total: three types of the length of X1 for 70 mm, 75 mm, and 80 mm; three types of the length of X2 for 5 mm, 7 mm, and 9 mm; and three types of the length of X3 for 95 mm, 100 mm, and 105 mm, as examples. The resonance frequency, the bandwidth where VSWR (Voltage Standing Wave Ratio) becomes below three, and the radiation efficiency are determined at each case. Here, when design parameters are obtained from an actual model, a three-dimensional scanner is used to easily obtain the values of the design parameters. VSWR is a voltage standing wave ratio, meaning that a return loss caused by impedance mismatching becomes greater as the VSWR becomes greater. Here, the VSWR is set below three in the range that accepts it as a loss caused by mismatching of the power supply impedance with the antenna impedance in antennas for practical use.

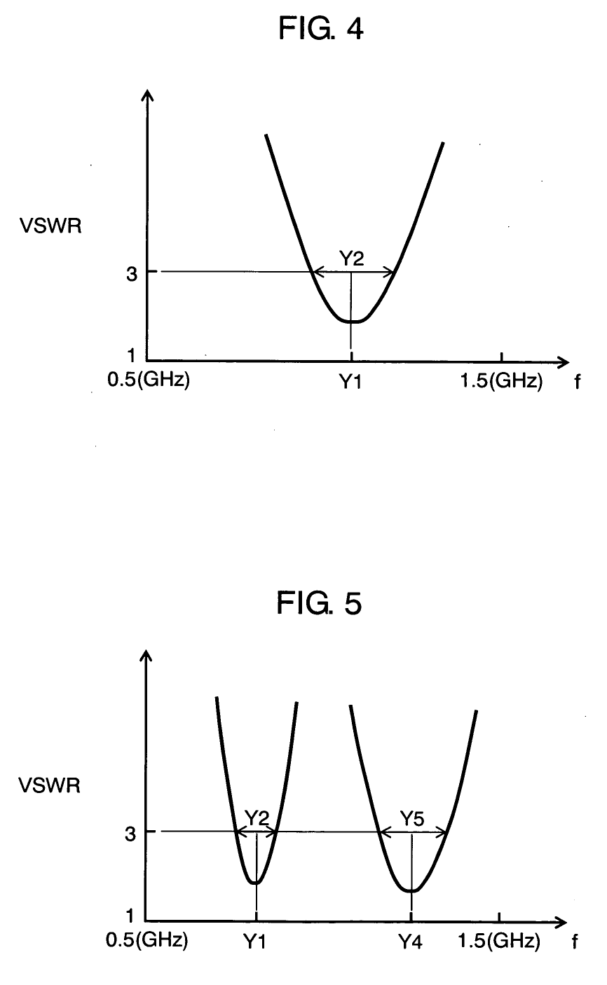

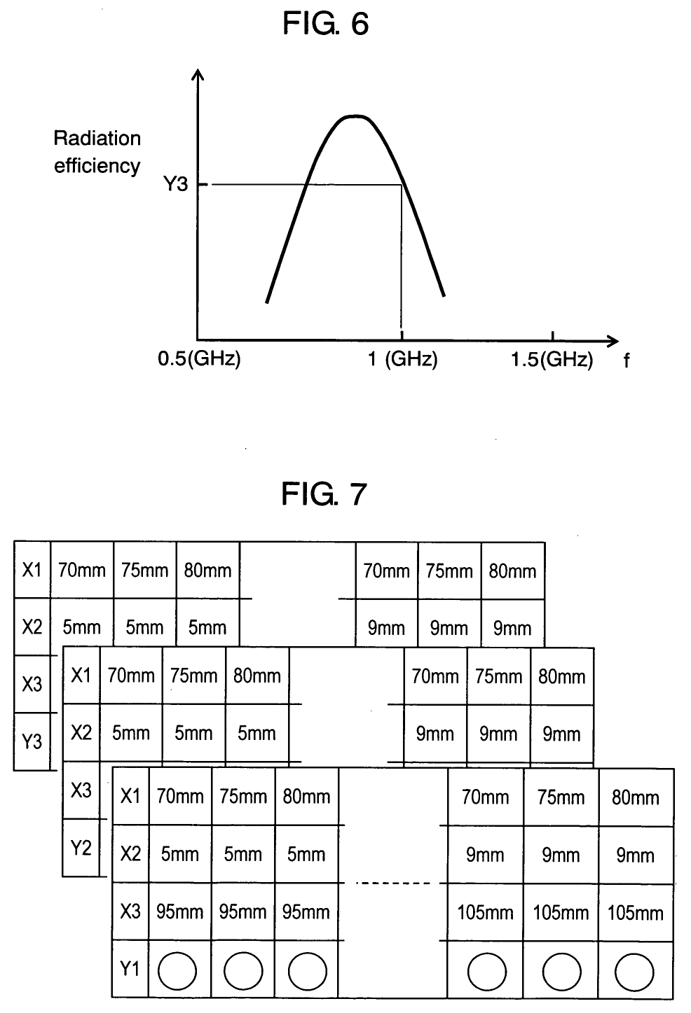

The range of evaluating the impedance characteristics is set from 0.5 [GHz] to 1.5 [GHz], and the frequency of evaluating the radiation efficiency is set to 1 [GHz]. Here, the cases will be described for one resonance and two resonances. Here, FIG. 4 is a diagram illustrating the frequency response of VSWR having one resonance between 0.5 [GHz] and 1.5 [GHz], and FIG. 5 is a diagram illustrating the frequency response of VSWR having two resonances between 0.5 [GHz] and 1.5 [GHz]. As shown in the embodiment, there might be the case of having a plurality of resonances in the specified range as shown in FIG. 5, depending on the structure of the antenna. As shown in FIG. 4, in the resonance when there is only one resonance within the range, the resonance frequency is set to Y1, the bandwidth is set to Y2 where the VSWR is below three, and the radiation efficiency at 1 [GHz] is set to Y3. As shown in FIG. 5, when there is a plurality of resonances within the range, the resonance frequency is set to Y1 in the first resonance, the bandwidth is set to Y2 where the VSWR is below three in the first resonance, and the radiation efficiency at 1 [GHz] is set to Y3 (FIG. 6) in the first resonance, and the resonance frequency is set to Y4 in the second resonance, and the bandwidth is set to Y5 where the VSWR in the second resonance is below three.

Here, in the example of the embodiment, how the characteristic parameters are varied depending on the design parameters will be described briefly. It is known that in a monopole antenna mounted on a board the board is also allowed to work as a part of the antenna, and then it is resonated when the antenna length is λ/4 (λ: wavelength). Here, since the frequency and the wavelength have the relationship of inverse proportion, the result is obtained that resonance frequency Y1 is decreased as antenna length X1 becomes longer. When a metallic conductor comes close to an antenna, that is, when length X2 becomes shorter, the impedance characteristics of the antenna are varied. Therefore, resonance frequency Y1, bandwidth Y2, and radiation efficiency Y3 are varied. As described above, in the monopole antenna mounted on the board, since the board also works as a part of the antenna, resonance frequency Y1, bandwidth Y2, and radiation efficiency Y3 change, when the length of the board is shifted from the ideal resonance length.

With the use of the design parameters above and the characteristic parameters obtained from numerical calculation, a database as shown in FIG. 7 is created. Here, since the design parameters have three variables and the characteristic parameters have three variables from FIG. 7, three tables are to be created in which three variables of the design parameters determine a single characteristic parameter. When there are two resonances in the range of evaluating the impedance characteristics, the design parameters have three variables, and the characteristic parameters have five variables. Thus, five tables are to be created in which three variables of the design parameters determine a single characteristic parameter.

More specifically, when the design parameters have M variables and the characteristic parameters have N variables, N tables are to be created in which M variables determine a single characteristic.

Then, a relational expression is derived from the data in this database.

Here, suppose the relationship of a linear summation is held between design parameters X and characteristic parameters Y. Y1, Y2, and Y3 can be expressed as (Expression 1) to (Expression 3) with X1, X2, and X3.
Y1=k₁₁·X1+k₂₁·X2+k₃₁·X3+A₁ (Expression 1)
Y2=k₁₂·X1+k₂₂·X2+k₃₁·X3+A₂ (Expression 2)
Y3=k₁₃·X1+k₂₃·X2+k₃₃·X3+A₃ (Expression 3)

Here, k₁₁ to k₃₃ are unknown variables.

Suppose (X2, Y2)=[(3, 950), (5, 990), (10, 1000), (15, 1005), (30, 1007)] is obtained from the database. Function f (X2) to be determined here is set as (Expression 4).
f (X2)=k₁₂·X2+A₂ (Expression 4)

In order to derive the optimum relational expression in the entire points, k₂₂ and A₂ are determined so that the total sum of square error as shown in (Expression 5) becomes the minimum. The five points are substituted into (Expression 5), and thus k₂₂=1.48, and A₂=971.72 are obtained.

$$E = {\sum }_{i \text{?} 1}^{n} {\vert {Y2}_{i} - f ( {X2}_{i} ) \vert}^{2} \\ \text{?} \text{indicates text missing or illegible when filed} \qquad ( Expression 5 )$$

This relational expression is used to obtain Y2 even when unknown X2 is newly given. Here, the relational expression only for Y2 and X2 is generated. However, even when the combination of design parameters X not existing in the database is given, the same procedures are performed, and then individual characteristic parameters Y corresponding thereto can be calculated.

Next, the example using the generated relational expressions according to the invention will be shown more specifically.

First, the case will be described that the same parameters as the inputted design parameters exist in the database. X1=75 mm, X2=7 mm, and X3=100 mm are inputted as design parameters, and resonance frequency Y1, bandwidth Y2, and radiation efficiency Y3 are determined at this time. When the inputted design parameters are compared with the design parameters in the database, resonance frequency Y1, bandwidth Y2, and radiation efficiency Y3 exist in the database. Therefore, resonance frequency Y1, bandwidth Y2, and radiation efficiency Y3 are obtained as the characteristic parameters from the database.

By the method described above, an antenna can be designed that has the optimum characteristics when mounted on an actual product.

Next, the case will be described that the same parameters as the inputted design parameters do not exist in the database, but the characteristic parameters can be derived from the relational expression. X1=75 mm, X2=7 mm, and X3=98 mm are inputted as design parameters, and resonance frequency Y1, bandwidth Y2, and radiation efficiency Y3 are determined at this time. Here, since the inputted design parameters X1, X2, and X3 do not exist in the database shown in FIG. 7, the relational expression formed of the design parameters and the characteristic parameters is used to obtain resonance frequency Y1, bandwidth Y2, and radiation efficiency Y3.

Next, the case will be described that a parameter beyond the range expressed by the relational expressions determined above is inputted.

FIG. 2 is a front view illustrating the monopole antenna when it is mounted on the circuit board, and FIG. 3 is a side view illustrating the monopole antenna when it is mounted on the circuit board. In FIG. 2, the length of antenna element 1 made of pure copper in the longitudinal direction is set to X1, the distance from the end part of the antenna to the end of shielding case 2 mounted on circuit board 3 is set to X2, the length of circuit board 3 in the longitudinal direction is set to X3, and the distance from the end of the antenna to speaker 4 is set to X4. Subsequently, X1=75 mm, X2=7 mm, X3=95 mm, and X4=3 mm are inputted as design parameters, and resonance frequency Y1, bandwidth Y2, and radiation efficiency Y3 are determined at this time. Here, since X1, X2, X3, and X4 do not exist in the database, resonance frequency Y1, bandwidth Y2, and radiation efficiency Y3 do not exist in the database. Since variable X4 does not also exist in the relational expressions (Expression 1) to (Expression 3) formed of the design parameters and the characteristic parameters, Y1, Y2, and Y3 cannot be obtained from the relational expressions as well. In this case, the electromagnetic field simulator is used to perform numerical calculation to obtain resonance frequency Y1, bandwidth Y2, and radiation efficiency Y3. The data obtained here by using the electromagnetic field simulator is newly stored in the database, and can be the data when this system is utilized next time.

As described above, according to the embodiment, the database of the characteristic parameters and the relational expression between the antenna design parameters and the characteristic parameters are utilized, and thus an antenna can be designed for a short time.

### Embodiment 2

Hereinafter, Embodiment 2 according to the invention will be described with reference to the drawings. Components having the same configuration as that of Embodiment 1 are omitted in the description.

For creating a database, the same procedures as those of Embodiment 1 are used. After the database is created, the relational expression is derived from the data in the database. In using this method, the data for use needs to be converted to a data format suitable for a neural network. It is desirable that the data given to the neural network as input is numbers from 0 to 1 in view of learning accuracy and learning speed.

It is considered that there are two types of data formats in the design parameters to be input parameters for the neural network: numerical data such as dimensions, and nonnumerical data such as types of antennas. Here, in consideration of learning accuracy and speed, it is desirable that the numerical data such as dimensions is normalized from 0 to 1, or converted to a form expressed only by 0 and 1 from binary numbers. In the meantime, it is desirable for the nonnumerical data such as the antenna types that numbers are first assigned to individual types and then normalized from 0 to 1, or it is converted to a form expressed only by 0 and 1 from binary numbers.

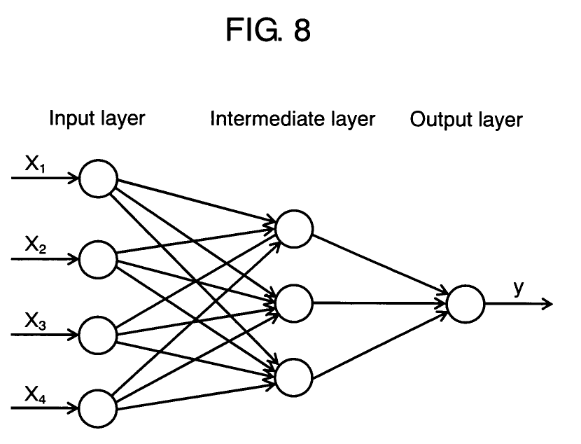

Next, the system which is created will be described. As shown in FIG. 8, the configuration of the system is formed of three layers: an input layer, an intermediate layer, and an output layer. The numbers of the input layer, the intermediate layer, and the output layer can be determined freely, but in FIG. 8, an example is taken that the input layer is four, the intermediate layer is three, and the output layer is one. The input layers and the intermediate layers, and the intermediate layers and the output layer are connected to each other with connections with weights. Here, in order to calculate the output from the intermediate layer, the value of the input layer is multiplied by the weight of the connection as shown in (Expression 6), it is given to the sigmoid function as shown in (Expression 7) as an input value, and thus the output is obtained.

$$\begin{matrix}S = {\sum }_{n \text{?} 0}^{N} {w}_{n} \cdot {x}_{n} & ( Expression 6 ) \\ {w}_{n} \text{:} weight of the connection & \\ {x}_{n} \text{:} input to the element & \\ y = sigmoid ( S ) , & ( Expression 7 ) \\ where & \\ sigmoid ( S ) = \frac{1}{1 + {ⅇ}^{\text{?}}} & \\ α \text{:} gain \\ \text{?} \text{indicates text missing or illegible when filed} & \end{matrix}$$

Subsequently, the same procedures are repeated as the output from the intermediate layer is the input. Therefore, the output value of the output layer is obtained. Here, the output from the output layer is called an output signal, and a characteristic parameter obtained by electromagnetic field analysis with the design parameters as input is called a teaching signal. The values of the output signal and the teaching signal are compared with each other with an error evaluation standard as shown in (Expression 8). When the value of (Expression 8) is greater, the weight of the connection inside the system is corrected and set so that the right-hand side of (Expression 8) becomes the minimum.

$$\begin{matrix}E = {\sum }_{i = 1}^{M} {\vert {b}_{i} - {t}_{i} \vert}^{2} \\ {b}_{i} \text{:} output signal \\ {t}_{i} \text{:} teaching signal\end{matrix} \qquad ( Expression 8 )$$

Suppose (X1, X2, Y2)=[(75, 10, 1000), (70, 3, 1020), (75, 1, 980), (60, 10, 1070), (70, 2, 960)] is obtained from the database. In the neural network, they are called a learning set. First, the data needs to be converted to the data suitable for the neural network. Here, the individual numeric values are normalized by the maximum values of X1, X2, and Y2. They are the result of normalization: (X1, X2, Y2)=[1, 1, 0.9345], (0.93, 0.3, 0.9533), (1, 0.1, 0.9159), (0.8, 1, 1), (0.93, 0.2, 0.8972)]. Here, X1, and X2 are called input signals, and Y2 is called teaching data. The neural network is constructed based on the data.

Hereinafter, the procedures of creating the neural network will be shown below.

[Procedure 1] First, the value of weight W in individual nodes is set randomly.

[Procedure 2] When a learning set (1, 1, 0.9345) is given, for example, inputs X1=1, and X2=1 are given to the system, and an output signal is obtained from (Expression 6), and (Expression 7).

[Procedure 3] Error is calculated from (Expression 8) based on the output signal and the teaching signal (0.9345, here).

[Procedure 4) Procedure 2 and Procedure 3 are done for all the learning sets to calculate the total sum of square error.

[Procedure 5] Here, a threshold value of error is set beforehand. When (Expression 8) is greater than the threshold value, the weight of the individual nodes is changed, and the procedures are repeated until (Expression 8) is below the threshold value.

By the procedures described above, the neural network that obtains the optimum output with respect to input is constructed. With the use of this system, the characteristic parameters can be obtained even when unknown design parameters not existing in the database are inputted.

When many factors and determinants complicatedly interact with each other as the antenna characteristics, it is really difficult to determine the relational expression between the design parameters and the characteristic parameters. Therefore, as compared with various approximation methods having premises that functions and relations are set beforehand, the neural network is used that has an advantage that it is sufficient that only input data and output data are known, and thus it becomes significantly efficient in the aspects of the accuracy of the output values and efforts to construct a system.

### Embodiment 3

Hereinafter, Embodiment 3 according to the invention will be described. For creating a database, the same procedures as those of Embodiment 1 are used. After the database is created, relational expressions are derived from the data in the database. Here, design parameter is set to xi, and the characteristic parameter is set to yᵢ. A single polynomial passing through N points (x₁, y₁), (x₂, y₂), (x₃, y₃) . . . (xₙ, yₙ) is determined from Lagrange interpolation, Newton interpolation, Neville interpolation, Chebyshev interpolation, and the like. Here, a method using Lagrange interpolation will be described.

Here, suppose a single polynomial passing through all the points is set to p(x), and then p(x₁)=y₁, p(x₂)=y₂, p(x₃)=y₃, . . . p(xₙ)=yₙ are satisfied. In the n-1th order polynomial like this, p(x) is given by (Expression 9) from the Lagrange interpolation formula.

$$p ( x ) = {\sum }_{i = 1}^{n} ( {y}_{\text{?}} {\prod }_{\text{?}}^{n} \frac{x - {x}_{\text{?}}}{{x}_{\text{?}} - {x}_{j}} ) \\ \text{?} \text{indicates text missing or illegible when filed} \qquad ( Expression 9 )$$

Therefore, the design parameters and the characteristic parameters corresponding thereto are substituted into (Expression 9), and thus p(x) can be derived. With the use of this system, the values of characteristic parameters y can be calculated even when unknown design parameters x are inputted.

Suppose (X2, Y2)=[(3, 950), (5, 990), (10, 1000), (15, 1005), (30, 1007)] is obtained from the database. A fourth order curve passing through five points is expressed by (Expression 10).

$$\begin{matrix}p ( x ) = 950 \cdot {N}_{1} + 990 \cdot {N}_{2} + 1000 \cdot {N}_{3} + \\ 1005 \cdot {N}_{4} + 1007 \cdot {N}_{5} \\ {N}_{1} = \frac{( x - 5 ) ( x - 10 ) ( x - 15 ) ( x - 30 )}{( 3 - 5 ) ( 3 - 10 ) ( 3 - 15 ) ( 3 - 30 )} \\ {N}_{2} = \frac{( x - 3 ) ( x - 10 ) ( x - 15 ) ( x - 30 )}{( 5 - 3 ) ( 5 - 10 ) ( 5 - 15 ) ( 5 - 30 )} \\ {N}_{3} = \frac{( x - 3 ) ( x - 5 ) ( x - 15 ) ( x - 30 )}{( 10 - 3 ) ( 10 - 5 ) ( 10 - 15 ) ( 10 - 30 )} \\ {N}_{4} = \frac{( x - 3 ) ( x - 5 ) ( x - 10 ) ( x - 30 )}{( 15 - 3 ) ( 15 - 5 ) ( 15 - 10 ) ( 15 - 30 )} \\ {N}_{5} = \frac{( x - 3 ) ( x - 5 ) ( x - 10 ) ( x - 15 )}{( 30 - 3 ) ( 30 - 5 ) ( 30 - 10 ) ( 30 - 15 )}\end{matrix} \qquad ( Expression 10 )$$

With the use of this system, even when design parameters not existing in the database are inputted, the design parameters are inputted into (Expression 10) to allow the characteristic parameters to be estimated. When this system is used, the order of the polynomial becomes higher as the data used in generating the relational expression more grows, and the accuracy of the estimated characteristic parameters can be enhanced. Accordingly, it becomes a significantly useful system as the scale of the database becomes greater.

### Embodiment 4

Hereinafter, Embodiment 4 according to the invention will be described. For creating a database, the same procedures as those of Embodiment 1 are used. After the database is created, relational expressions are derived from the data in the database. Here, suppose the design parameter is set to xᵢ, and the characteristic parameter is set to yᵢ. In order to determine a Be'zier curve passing through N points (x₁, y₁), (x₂, y₂), (x₃, y₃) . . . (xₙ, yₙ), the Bernshtein polynomial expressed by (Expression 11) is first used.
Bₚ(s)=ₙCₚs^{p}(1−s)^{n-p} (Expression 11)

(Expression 11) is used, and the Be'zier curve is expressed by (Expression 12) and (Expression 13) where s is a variable.

$$\begin{matrix}x ( s ) = {\sum }_{p = 0}^{n} {x}_{p} {B}_{p} ( s ) & ( Expression 12 ) \\ y ( s ) = {\sum }_{p = 0}^{n} {y}_{p} {B}_{p} ( s ) & ( Expression 13 )\end{matrix}$$

In (Expression 12) and (Expression 13), s is varied in 0≦s≦1, and thus the combination of x, y not existing in the database can be estimated. Accordingly, a new database for x, y can be created. Here, the number of data in the database newly created is more increased as the pitch of s is smaller, and thus the probability that the inputted design parameters exist in the database is increased.

Suppose (X2, Y2)=[(3, 950), (5, 990), (10, 1000), (15, 1005), (30, 1007)] is obtained from the database. A fourth order curve passing through five points is expressed by (Expression 14).

$$\begin{matrix}{X}_{2} ( s ) = 3 \cdot ( {}_{5}^{}{C}{}_{1}^{} \cdot {s}^{1} \cdot {( 1 - s )}^{5 - 1} ) + \\ 5 \cdot ( {}_{5}^{}{C}{}_{2}^{} \cdot {s}^{2} \cdot {( 1 - s )}^{5 - 2} ) + \\ 10 \cdot ( {}_{5}^{}{C}{}_{3}^{} \cdot {s}^{3} \cdot {( 1 - s )}^{5 - 3} ) + \\ 15 \cdot ( {}_{5}^{}{C}{}_{4}^{} \cdot {s}^{4} \cdot {( 1 - s )}^{5 - 4} ) + \\ 30 \cdot ( {}_{5}^{}{C}{}_{5}^{} \cdot {s}^{5} \cdot {( 1 - s )}^{5 - 5} ) \\ {Y}_{2} ( s ) = 950 \cdot ( {}_{5}^{}{C}{}_{1}^{} \cdot {s}^{1} \cdot {( 1 - s )}^{5 - 1} ) + \\ 990 \cdot ( {}_{5}^{}{C}{}_{2}^{} \cdot {s}^{2} \cdot {( 1 - s )}^{5 - 2} ) + \\ 1000 \cdot ( {}_{5}^{}{C}{}_{3}^{} \cdot {s}^{3} \cdot {( 1 - s )}^{5 - 3} ) + \\ 1005 \cdot ( {}_{5}^{}{C}{}_{4}^{} \cdot {s}^{4} \cdot {( 1 - s )}^{5 - 4} ) + \\ 1007 \cdot ( {}_{5}^{}{C}{}_{5}^{} \cdot {s}^{5} \cdot {( 1 - s )}^{5 - 5} )\end{matrix} \qquad ( Expression 14 )$$

Here, in order to newly create a database where X2 and Y2 make a pair with the points on a Be'zier curve, s is varied at a 0.001 pitch in 0≦s≦1, and new X2 and Y2 are obtained from (Expression 14).

When this system is used, the number of data in a database can be increased with no complicated calculation for system construction. Accordingly, it is useful for the case where a database already has enormous data and it is expected to take much calculation time to derive a relational expression by other methods.

### Embodiment 5

Hereinafter, Embodiment 5 according to the invention will be described. For creating a database, the same procedures as those of Embodiment 1 are used. After the database is created, a relational expression is derived from the data in the database. Here, the design parameter is set to xᵢ, and the characteristic parameter is set to yᵢ.

In order to obtain a piecewise polynomial from N points (x₁, y₁), (x₂, y₂), (x₃, y₃) . . . (xₙ, yₙ), spline interpolation, B-spline interpolation, NURBS, and the like are considered. Here, an example using third-order interpolation will be described.

Suppose a third-order polynomial in the interval [xᵢ, xᵢ₊₁] is Sᵢ(x), it can be expressed by (Expression 15).
Sᵢ(x)=aₗ+bᵢ(x−xₗ)+cᵢ(x−xᵢ)²+dᵢ(x−xₗ)³ (Expression 15)

However, the premise is to hold (Expression 16).
Sᵢ(xᵢ)=y₁ (1)
Sᵢ(xₗ)=Sₗ₊₁′(xᵢ)·Sᵢ″(xₗ)=Sₗ₊₁″(xₗ) (2)
f″(xₗ)=f″(xₙ₊₁)=0 (3)
or
f′(xₗ)=y′₁ and f′(xₙ₊₁)=y′ₙ₊₁ (Expression 16)

(Expression 17) is obtained from (Expression 15) and (Expression 16).

$$\begin{matrix}{h}_{i + 1} {y}_{i - 1}^{′} + 2 \cdot ( {h}_{\text{?}} + {h}_{i - 1} ) {y}_{i}^{′} + {h}_{\text{?}} {y}_{i + 1}^{′} = & ( Expression 17 ) \\ 3 [ \frac{{y}_{i} - {y}_{i - 1}}{{h}_{i}} {h}_{i + 1} + \frac{{y}_{i + 1} - {y}_{\text{?}}}{{h}_{i + 1}} {h}_{\text{?}} ] & \\ where & \\ {h}_{i} = {x}_{i} - {x}_{i - 1} & ( Expression 18 ) \\ \begin{matrix}Δ {y}_{i} = \frac{{y}_{i} - {y}_{i - 1}}{{h}_{\text{?}}} , & Δ {y}_{i + 1} = \frac{{y}_{i + 1} - {y}_{\text{?}}}{{h}_{i + 1}}\end{matrix} \\ \text{?} \text{indicates text missing or illegible when filed} & \end{matrix}$$

The recurrence formula of (Expression 17) is formed into a form of simultaneous equations, and the simultaneous equations are solved by being converted to a determinant as shown in (Expression 19). However, since two unknowns are excessive, boundary condition (3) in (Expression 16) is used to determine y₁′. Here, the coefficient of y₁′ in (Expression 17) is Aⱼᵢ, and the right-hand side is Bᵢ.

$$\begin{matrix}[ \begin{matrix}{A}_{11} & {A}_{12} & {A}_{13} & & & & & 0 \\ & {A}_{22} & {A}_{23} & {A}_{24} & & & & \\ & & & & ⋰ & & & \\ 0 & & & & & {A}_{\text{?}} & {A}_{\text{?}} & {A}_{\text{?}}\end{matrix} ] \\ [ \begin{matrix}{y}_{1}^{′} \\ {y}_{2}^{′} \\ ⋮ \\ {y}_{\text{?}}^{′}\end{matrix} ] = [ \begin{matrix}{B}_{1} \\ {B}_{2} \\ ⋮ \\ {B}_{n}\end{matrix} ] \\ \text{?} \text{indicates text missing or illegible when filed}\end{matrix} \qquad ( Expression 19 )$$

aᵢ, bᵢ, cᵢ, and dᵢ in (Expression 15) are expressed by (Expression 20) with y₁′.

$$\begin{matrix}{a}_{i} = {y}_{\text{?}} \\ {b}_{i} = {y}_{i}^{′} \\ {c}_{i} = ( 3 \cdot Δ {y}_{i + 1} - 2 \cdot {y}_{1}^{′} - {y}_{i + 1}^{′} ) \cdot {h}_{i + 1} \\ {d}_{i} = \frac{( {y}_{i + 1}^{′} + {y}_{1}^{′} - 2 \cdot Δ {y}_{i + 1} )}{{h}_{i + 1}} \\ \text{?} \text{indicates text missing or illegible when filed}\end{matrix} \qquad ( Expression 20 )$$

(Expression 20) is calculated and substituted into (Expression 15), and then the relational expression is created. By this system, the values of characteristic parameters y can be calculated even when unknown design parameters x are inputted.

Suppose (X2, Y2)=[(3, 950), (5, 990), (10, 1000), (15, 1005), (30, 1007)] is obtained from the database. A third-order spline function passing through these five points is expressed by (Expression 15).

When the five points described above existing in the database are inputted into (Expression 15), a determinant of (Expression 21) is obtained.

$$( \begin{matrix}5 & 2 ( 1 + 2 ) & 1 & \\ & 15 & 2 ( 5 + 1 ) & 5\end{matrix} ) ( \begin{matrix}{y}_{1}^{′} \\ {y}_{2}^{′} \\ {y}_{3}^{′} \\ {y}_{4}^{′}\end{matrix} ) = ( \begin{matrix}3 ( \frac{1000 - 990}{1} \cdot 5 + \frac{1005 - 1000}{5} \cdot 1 ) \\ 3 ( \frac{1005 - 1000}{1} \cdot 15 + \frac{1007 - 1005}{15} \cdot 5 )\end{matrix} ) \qquad ( Expression 21 )$$

y₁′, y₂′, y₃′ and y₄′ are determined from (Expression 21), and then third polynomial in the individual intervals are determined.

When this system is used, significantly high approximation capability is provided because applied polynomial expressions are varied depending on the range where the inputted design parameters exist. Accordingly, the characteristic parameters can be estimated highly accurately.

### Embodiment 6

Hereinafter, Embodiment 6 according to the invention will be described. For creating a database, the same procedures as those of Embodiment 1 are used. After the database is created, a relational expression is derived from the data in the database. Here, suppose the design parameter is set to xᵢ, and the characteristic parameter is to yᵢ. In order to determine a rational Be'zier curve from n points (x₁, y₁), (x₂, y₂), (x₃, y₃) . . . (xₙ, yₙ), a Bernshiein polynomial expressed by (Expression 22) is first used.
Bₚ(s)=ₙCₚsⁿ(1−s)^{n-p} (Expression 22)

(Expression 22) is used to assign weights on the individual nodes, and thus a curve more flexible than the Be'zier curve can be obtained. The expression when the individual nodes are assigned weights is expressed by (Expression 23).

$$\begin{matrix}x ( s ) = \frac{{\sum }_{k = 0}^{np - 1} {w}_{k} {x}_{k} {B}_{k} ( s )}{{\sum }_{k = 0}^{np - 1} {w}_{k} {B}_{k} ( s )} & ( Expression 23 ) \\ y ( s ) = \frac{{\sum }_{k = 0}^{op - 1} {w}_{k} {y}_{k} {B}_{k} ( s )}{{\sum }_{k = 0}^{op - 1} {w}_{k} {B}_{k} ( s )} & ( Expression 24 )\end{matrix}$$

s is varied in 0≦s≦1 in (Expression 23) and (Expression 24), and the combination of x, y not existing in the database can be estimated. Therefore, a new database for x, y can be created. Here, the number of data in the database newly created is more increased as the pitch of s is smaller. Thus, the probability that the inputted design parameters exist in the database is increased.

Suppose (X2, Y2)=[(3, 950), (5, 990), (10, 1000), (15, 1005), (30, 1007)] is obtained from the database. However, suppose, the reliability of data is varied on the data. Here, suppose the reliability of data is 0.5, 0.3, 0.3, 1, 0.8 in the individual points (3, 950), (5, 990), (10, 1000), (15, 1005), (30, 1007), and the reliability of the data is a weight for each point to calculate (Expression 23) and (Expression 24). Consequently, a fourth rational Be'zier curve is expressed by (Expression 25).

$$\\ {X}_{2} ( s ) = \frac{\begin{matrix}0.5 \cdot 3 \cdot ( {}_{5}^{}{C}{}_{1}^{} \cdot {{s}^{1} ( 1 - s )}^{5 - 1} ) + 0.3 \cdot 5 \cdot ( {}_{5}^{}{C}{}_{2}^{} \cdot {s}^{2} \cdot \\ {( 1 - s )}^{5 - 2} ) + 0.3 \cdot 10 \cdot ( {}_{5}^{}{C}{}_{3}^{} \cdot {s}^{3} \cdot {( 1 - s )}^{5 - 3} ) + \\ 145 \cdot ( {}_{5}^{}{C}{}_{4}^{} \cdot {s}^{4} \cdot {( 1 - s )}^{5 - 4} ) + 0.8 \cdot 30 \cdot \\ ( {}_{5}^{}{C}{}_{5}^{} \cdot {s}^{3} \cdot {( 1 - s )}^{3 - 5} )\end{matrix}}{\begin{matrix}\begin{matrix}0.5 \cdot ( {}_{5}^{}{C}{}_{1}^{} \cdot {s}^{1} \cdot {( 1 - s )}^{5 - 1} + 0.3 \cdot ( {}_{5}^{}{C}{}_{2}^{} \cdot {s}^{2} \cdot \\ {( 1 - s )}^{5 - 2} ) + 0.3 \cdot ( {}_{5}^{}{C}{}_{3}^{} \cdot {s}^{3} \cdot {( 1 - s )}^{5 - 3} ) +\end{matrix} \\ 1 \cdot ( {}_{5}^{}{C}{}_{4}^{} \cdot {s}^{4} \cdot {( 1 - s )}^{5 - 4} ) + 0.8 \cdot ( {}_{5}^{}{C}{}_{5}^{} \cdot {s}^{3} \cdot {( 1 - s )}^{5 - 3} )\end{matrix}} \\ {Y}_{2} ( s ) = \frac{\begin{matrix}\begin{matrix}0.5 \cdot 950 \cdot ( {}_{5}^{}{C}{}_{1}^{} \cdot {s}^{1} \cdot {( 1 - s )}^{5 - 1} ) + 0.3 \cdot 990 \cdot ( {}_{5}^{}{C}{}_{2}^{} \cdot {s}^{2} \cdot \\ {( 1 - s )}^{5 - 2} ) + 0.3 \cdot 1000 \cdot ( {}_{5}^{}{C}{}_{2}^{} \cdot {s}^{3} \cdot {( 1 - s )}^{5 - 3} ) +\end{matrix} \\ 1 \cdot 1005 \cdot {(}_{5} {C}_{4} \cdot {s}^{4} \cdot {( 1 - s )}^{5 - 4} ) + 0.8 \cdot 1007 \cdot \\ ( {}_{5}^{}{C}{}_{5}^{} \cdot {s}^{5} \cdot {( 1 - s )}^{5 - 5} )\end{matrix}}{\begin{matrix}\begin{matrix}0.5 \cdot ( {}_{5}^{}{C}{}_{1}^{} \cdot {s}^{1} \cdot {( 1 - s )}^{5 - 2} ) + 0.3 \cdot ( {}_{5}^{}{C}{}_{2}^{} \cdot {s}^{2} \cdot {( 1 - s )}^{5 - 2} ) + \\ 0.3 \cdot ( {}_{5}^{}{C}{}_{2}^{} \cdot {s}^{3} \cdot {( 1 - s )}^{5 - 3} ) + 1 \cdot \end{matrix} \\ ( {}_{5}^{}{C}{}_{4}^{} \cdot {s}^{4} \cdot {( 1 - s )}^{5 - 4} ) + 0.8 ( {}_{5}^{}{C}{}_{5}^{} \cdot {s}^{3} \cdot {( 1 - s )}^{3 - 5} )\end{matrix}} \qquad ( Expression 25 )$$

Here, in order to newly crate a database where X2 and Y2 make a pair with the points on the rational Be'zier curve, s is varied in 0≦s≦1 at a 0.001 pitch, and then X2 and Y2 are obtained from (Expression 25).

When this system is used, the number of data in a database can be increased with no complicated calculation for system construction. Therefore, it is useful for the case where a database already has enormous volume of data and it is expected to require a quite long calculation time to derive relational expressions by other methods. In addition, when there are variations in the reliability of data stored in the database, this system is used to reconstruct a highly accurate database.

### Embodiment 7

Hereinafter, Embodiment 7 according to the invention will be described. For creating a database, the same procedures as those of Embodiment 1 are used. After the database is created, a relational expression is derived from the data in the database. Here, suppose the design parameter is set to xᵢ, and the characteristic parameter is set to yᵢ. When N points (x₁, y₁), (x₂, y₂), (x₃, y₃) . . . (xₙ, yₙ) can be expressed by a periodic function, interpolation by a trigonometric function is used.

Approximation using the trigonometric function is expressed by (Expression 26) from the Fourier series.

$$\begin{matrix}\int ( x ) = {a}_{n} + {\sum }_{n = 1}^{∞} ( {a}_{n} cos wx + {b}_{k} sin wx ) , where & ( Expression 26 ) \\ \begin{matrix}{a}_{o} = \frac{1}{T} {\int }_{0}^{T} f ( x ) ⅆ x \\ {a}_{n} = \frac{2}{T} {\int }_{0}^{T} f ( x ) cos nw \times ⅆ x \\ {b}_{n} = \frac{2}{T} {\int }_{0}^{T} f ( x ) sin nw \times ⅆ x\end{matrix} & ( Expression 27 )\end{matrix}$$

The individual points are substituted into (Expression 27) to determine coefficients in (Expression 26), and thus the relational expression of the design parameters and the characteristic parameters is generated. With the use of this system, the values of characteristic parameters y can be calculated even when unknown design parameters x are inputted.

Suppose regular interval data (X2, Y2)=[(1, 900), (3, 950), (5, 990), (7, 994), (9, 998)] with respect to X2 is obtained from the database. A function passing through five points is expressed by (Expression 28).

$$( Expression 28 )$$

$${a}_{0} = \frac{( 900 + 950 + 990 + 994 + 998 )}{4}$$

$${a}_{1} = ( \begin{matrix}900 \cdot cos ( 2 π \cdot \frac{0}{4} ) + 950 \cdot cos ( 2 π \cdot \frac{1}{4} ) + 990 \cdot cos ( 2 π \cdot \frac{2}{4} ) + \\ 994 \cdot cos ( 2 π \cdot \frac{3}{4} ) + 998 \cdot cos ( 2 π \cdot \frac{4}{4} )\end{matrix} ) \times \frac{2}{4}$$

$${a}_{2} = ( \begin{matrix}900 \cdot cos ( 4 π \cdot \frac{0}{4} ) + 950 \cdot cos ( 4 π \cdot \frac{1}{4} ) + 990 \cdot cos ( 4 π \cdot \frac{2}{4} ) + \\ 994 \cdot cos ( 4 π \cdot \frac{3}{4} ) + 998 \cdot cos ( 4 π \cdot \frac{4}{4} )\end{matrix} ) \times \frac{2}{4}$$

$${a}_{n} = ( \begin{matrix}900 \cdot cos ( 2 n π \cdot \frac{0}{4} ) + 950 \cdot cos ( 2 n π \cdot \frac{1}{4} ) + 990 \cdot cos ( 2 n π \cdot \frac{2}{4} ) + \\ 994 \cdot cos ( 2 n π \cdot \frac{3}{4} ) + 998 \cdot cos ( 2 n π \cdot \frac{4}{4} )\end{matrix} ) \times \frac{2}{4}$$

$${b}_{1} = ( \begin{matrix}900 \cdot sin ( 2 π \cdot \frac{0}{4} ) + 950 \cdot sin ( 2 π \cdot \frac{1}{4} ) + 990 \cdot sin ( 2 π \cdot \frac{2}{4} ) + \\ 994 \cdot sin ( 2 π \cdot \frac{3}{4} ) + 998 \cdot sin ( 2 π \cdot \frac{4}{4} )\end{matrix} ) \times \frac{2}{4}$$

$${b}_{2} = ( \begin{matrix}900 \cdot sin ( 4 π \cdot \frac{0}{4} ) + 950 \cdot sin ( 4 π \cdot \frac{1}{4} ) + 990 \cdot sin ( 4 π \cdot \frac{2}{4} ) + \\ 994 \cdot sin ( 4 π \cdot \frac{3}{4} ) + 998 \cdot sin ( 4 π \cdot \frac{4}{4} )\end{matrix} ) \times \frac{2}{4}$$

$${b}_{n} = ( \begin{matrix}900 \cdot sin ( 2 n π \cdot \frac{0}{4} ) + 950 \cdot sin ( 2 n π \cdot \frac{1}{4} ) + 990 \cdot sin ( 2 n π \cdot \frac{2}{4} ) + \\ 994 \cdot sin ( 2 n π \cdot \frac{3}{4} ) + 998 \cdot sin ( 2 n π \cdot \frac{4}{4} )\end{matrix} ) \times \frac{2}{4}$$

(Expression 28) is substituted into (Expression 26), and thus the relational expression can be derived. Here, the accuracy of the relational expression is higher as the number of n is more increased. In the case of using this system, when a design parameter to be inputted is set to X2, it needs to be X2=(X2−1)/2 in inputting it into the completed relational expression.

When this system is used, it has constraints that the system is used only when the input parameters having regular interval exist on the database. However, since the system has significantly high approximation capability, it is highly useful when expectation cannot be made at all what relational expressions are formed, for example in the design parameters and the characteristic parameters in designing antennas.

As described above, when an antenna is designed in consideration of actual devices such as cellular telephones and the like, the invention uses the database prepared beforehand with electromagnetic field simulation and the relational expression obtained from the design parameters and the characteristic parameters for design. Accordingly, the time for antenna design is shortened, and thus the invention greatly contributes to reduction in costs of antenna development.

The design method for the antenna according to the invention is useful as a tool that designs an optimum antenna matching with the configuration of a cellular telephone for a short time.

1. A design method for an antenna comprising the steps of:
determining a material and dimensions of individual parts forming an antenna as design parameters;
then comparing values of the design parameters with a database;
acquiring characteristics of a database when there is the database with which the design parameters are matched in the comparison step; and
acquiring characteristics predicted from a relational expression obtained by interpolating or extrapolating data in the database when there is no database with which the design parameters are matched in the comparison step.

2. The design method for the antenna according to claim 1, wherein the material and the dimensions of the individual parts of the antenna to be the design parameters of the antenna and the characteristics of the antenna determined by the design parameters make pairs, and are stored in the database as attributes.

3. The design method for the antenna according to claim 1, wherein a shape of an antenna, a plating form applied inside a case of a cellular telephone, distances from the antenna to its peripheral parts, and a shape of a circuit board on which the antenna is to be mounted are selected for the antenna design parameters in the database.

4. The design method for the antenna according to claim 1, wherein a resonance frequency, a bandwidth, and radiation efficiency are selected for the antenna characteristics in the database.

5. The design method for the antenna according to claim 1, wherein data in the database is created by electromagnetic field simulation.

6. The design method for the antenna according to claim 5, wherein a simulation model used for the electromagnetic field simulation is created based on electronic data that an antenna, a case of a cellular telephone, a circuit board, and peripheral components of the antenna are taken by a three-dimensional laser scanner.

7. The design method for the antenna according to claim 1, wherein in the relational expression, the antenna characteristics are expressed by a linear summation of the antenna design parameters.

8. The design method for the antenna according to claim 1, wherein the relational expression is determined from the antenna characteristics and the design parameters by using a neural network.

9. The design method for the antenna according to claim 1, wherein the relational expression is determined from the antenna characteristics and the design parameters by using a single interpolation polynomial.

10. The design method for the antenna according to claim 1, wherein the relational expression is determined from the antenna characteristics and the design parameters by using a Be'zier curve.

11. The design method for the antenna according to claim 1, wherein the relational expression is determined from the antenna characteristics and the design parameters by using a piecewise polynomial.

12. The design method for the antenna according to claim 1, wherein the relational expression is determined from the antenna characteristics and the design parameters by using a rational Be'zier curve.

13. The design method for the antenna according to claim 1, wherein the relational expression is determined from the antenna characteristics and the design parameters by using interpolation done by a trigonometric function.

14. An antenna designed by using a design method comprising the steps of:
determining a material and dimensions of individual parts forming an antenna as design parameters:
then comparing values of the design parameters with a database:
acquiring characteristics of a database when there is the database with which the design parameters are matched in the comparison step; and
acquiring characteristics predicted from a relational expression obtained by interpolating or extrapolating data in the database when there is no database with which the design parameters are matched in the comparison step.

15. An antenna according to claim 14, wherein the material and the dimensions of the individual parts of the antenna to be the design parameters of the antenna and the characteristics of the antenna determined by the design parameters make pairs, and are stored in the database as attributes.

16. An antenna according to claim 14, wherein a shape of an antenna, a plating form applied inside a case of a cellular telephone, distances from the antenna to its peripheral parts, and a shape of a circuit board on which the antenna is to be mounted are selected for the antenna design parameters in the database.

17. An antenna according to claim 14, wherein a resonance frequency, a bandwidth, and radiation efficiency are selected for the antenna characteristics in the database.

18. An antenna according to claim 14, wherein data in the database is created by electromagnetic field simulation.

19. An antenna according to claim 14, wherein a simulation model used for the electromagnetic field simulation is created based on electronic data that an antenna, a case of a cellular telephone, a circuit board, and peripheral components of the antenna are taken by a three-dimensional laser scanner.

20. An antenna according to claim 14, wherein in the relational expression, the antenna characteristics are expressed by a linear summation of the antenna design parameters.

21. An antenna according to claim 14, wherein the relational expression is determined from the antenna characteristics and the design parameters by using a neural network.

22. An antenna according to claim 14, wherein the relational expression is determined from the antenna characteristics and the design parameters by using a single interpolation polynomial.

23. An antenna according to claim 14, wherein the relational expression is determined from the antenna characteristics and the design parameters by using a Be'zier curve.

24. An antenna according to claim 14, wherein the relational expression is determined from the antenna characteristics and the design parameters by using a piecewise polynomial.

25. An antenna according to claim 14, wherein the relational expression is determined from the antenna characteristics and the design parameters by using a rational Be'zier curve.

26. An antenna according to claim 14, wherein the relational expression is determined from the antenna characteristics and the design parameters by using interpolation done by a trigonometric function.
